(19) United States
(12) Patent Application Publication
(10) Pub. No.: US 2026/0134655 A1
(43) Pub. Date: May 14, 2026

(54) EFFICIENT VISUAL ENCODING USING LIGHTWEIGHT VISUAL ENCODERS

(71) Applicant: Adobe Inc., San Jose, CA (US)

(72) Inventors: Mattia SOLDAN, Thuwal (SA); Fabian David CABA HEILBRON, San Jose, CA (US); Bryan RUSSELL, San Francisco, CA (US); Josef SIVIC, Prague (CZ)

(73) Assignee: Adobe Inc., San Jose, CA (US)

(21) Appl. No.: 18/942,192

(22) Filed: Nov. 8, 2024

(51) Int. Cl. G06V 10/44; G06V 10/75; G06V 10/80

(52) U.S. Cl. CPC G06V 10/44; G06V 10/751; G06V 10/806

(57) ABSTRACT

Embodiments are disclosed for a video frame encoding system trained to generate a visual features from video frames of a video sequence using a lightweight visual encoder. The method may include generating, by a visual encoder, first visual features for a first video frame of a video sequence. The disclosed systems and methods further comprise generating, by a lightweight visual encoder, first residual visual features for a first residual video frame, wherein the first residual video frame is based on the first video frame of the video sequence and a second video frame of the video sequence subsequent to the first video frame. The disclosed systems and methods further comprise generating second visual features for the second video frame of the video sequence by aggregating the first visual features and the first residual visual features.

### BACKGROUND

Visual encoding is the process of representing visual content of an image or video sequence as a feature representation. Visual encoding has a variety of applications, including searching content databases. For example, the ability to search through video databases to create such creative content is a main feature of video editing applications. However, as video can be very data heavy, encoding every full frame of a video can be both resource expensive and time-consuming, making deployment at scale difficult.

### SUMMARY

Introduced here are techniques/technologies that allow a video frame encoding system to efficiently generate visual features for frames of a video sequence by using a full foundation encoder model to generate the visual features of a sparse set of video frames of a video sequence and training a lightweight encoder model to generate an efficient approximation of the visual features for a dense set of residual video frames.

More specifically, in one or more embodiments, a video frame encoding system generates visual features for video frames of a video sequence using a pair of visual encoders: a full foundation visual encoder model and a lightweight visual encoder model. Video compression methods typically store a sparse set of I-frames (e.g., self-contained, full video frames) and a dense set of P-frames (e.g., video frames that represent the pixelwise differences or changes from previous video frames). The video frame encoding system leverages the fact that nearby video frames of a video typically have a large temporal redundancy (e.g., they are visually similar) to minimize the number of full video frames processed by the full foundation visual encoder model. The video frame encoding system thus processes the sparse set of video frames of the video sequence through the full foundation visual encoder model to generate their actual full visual features, while using the lightweight visual encoder model to process the remaining dense set of video frames to generate approximations of their visual features. The lightweight visual encoder model is trained to minimize the loss between the visual features output by the lightweight visual encoder model and the visual features output by the full foundation visual encoder model.

In one or more embodiments, a first video frame of a video sequence is processed through the full foundation visual encoder model to generate the first visual features. Then, instead of processing a full version of a second video frame through the full foundation visual encoder model, the video frame encoding system retrieves or generates a residual version of the second video frame that represents the pixelwise differences between the first video frame and the second video frame. As consecutive or adjacent video frames are usually visually similar, the pixelwise differences can be small, resulting in the residual version of the second video frame being less data heavy. The residual version of the second video frame is then processed through the lightweight visual encoder model to generate residual visual features of the second video frame. The residual visual features of the second video frame are then aggregated with the full visual features of the nearest video frame processed through the full foundation visual encoder model (e.g., the first video frame) to generate an approximation of the full visual features of the second video frame. This process can be repeated for each video frame of the dense set of video frames by aggregating their corresponding residual visual features with the full visual features of the nearest video frame processed through the full foundation visual encoder model.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of encoding video frames of a video sequence using a trained lightweight visual encoder in accordance with one or more embodiments;

FIG. 2 illustrates exemplary video frames processed through a video frame encoding system in accordance with one or more embodiments;

FIG. 3 illustrates a diagram of a process of training a lightweight visual encoder of a video frame encoding system to generate visual features using residual video frames in accordance with one or more embodiments;

FIG. 4 illustrates a schematic diagram of a video frame encoding system in accordance with one or more embodiments;

FIG. 5 illustrates a flowchart of a series of acts in a method of generating visual features for frames of a video sequence using a lightweight visual encoder in accordance with one or more embodiments;

FIG. 6 illustrates a flowchart of a series of acts in a method of training a lightweight visual encoder to generate visual features for frames of video sequences in accordance with one or more embodiments; and

FIG. 7 illustrates a block diagram of an exemplary computing device in accordance with one or more embodiments.

### DETAILED DESCRIPTION

One or more embodiments of the present disclosure include a video frame encoding system trained to efficiently generate visual features for video frames of a video sequence using a trained lightweight visual encoder.

Traditionally, deep-learning video pipelines process video frames extracted from videos. This video decoding operation introduces a computational overhead and may make it computationally inefficient. While some methods improve access time by pre-extracting and storing all frames, they also significantly increase storage needs. For instance, a conventional one-hour long, 720p resolution, video can be stored in approximately 1 GB or decoded in over 200 GB, making this solution impractical in today's large-scale data landscape.

Deploying foundation models to every video frame can be time and resource expensive. For example, to naively compute the visual features for every video frame of a dataset of 19 million Adobe Stock videos using high-end A100 GPUs would require over 192,000 GPU hours using a full foundation model. Some existing techniques to reduce the required compute resources attempt to distill the foundation model's representation directly into a lower-capacity model. However, while such efforts result in a more efficient model, it is challenging to store all of the information from the larger model into the smaller model, resulting in a degradation of recognition accuracy. Moreover, these approaches treat each video frame independently and do not explicitly take advantage of the temporal redundancy that is inherent in videos.

To address these and other deficiencies in conventional systems, the video frame encoding system of the present disclosure includes lightweight visual encoder model (e.g., a neural network) trained to emulate the behavior of a full foundation visual encoder model when generating visual features for video frames of a video sequence. This allows for a sparse set of video frames to be processed by the full foundation visual encoder model, while a dense set of video frames are processed by the lightweight visual encoder model that has a higher compute efficiency than the full foundation visual encoder model.

The video frame encoding system of the present disclosure presents improved visual encoding that addresses the limitations of the existing solutions. One advantage of the video frame encoding system of the present disclosure is a reduction in computational costs by processing some video frames of a video sequence as residual video frames through a lightweight visual encoder model, thereby reducing or minimizing the number of video frames being processed through a full foundation visual encoder model.

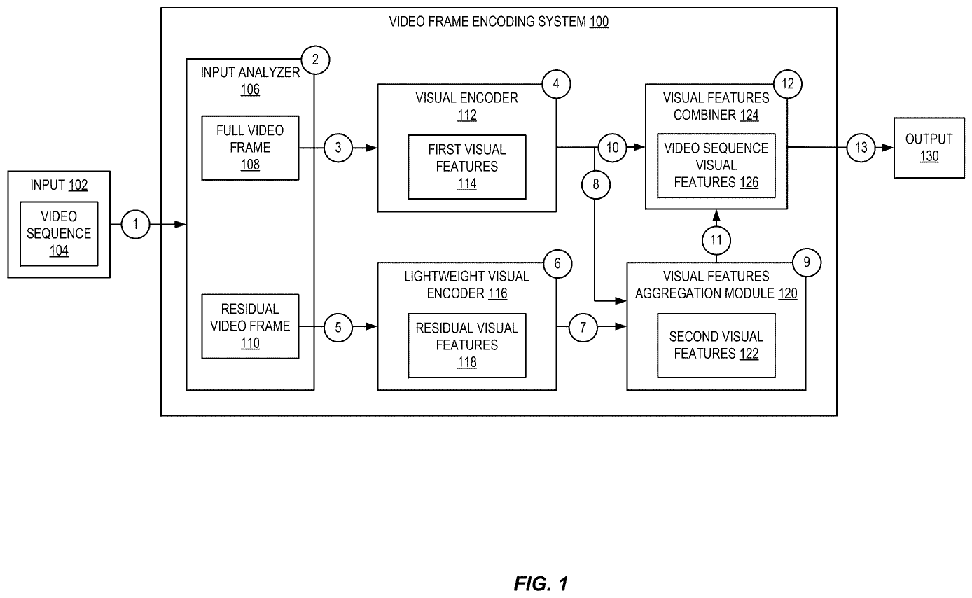

FIG. 1 illustrates a diagram of a process of encoding video frames of a video sequence using a trained lightweight visual encoder in accordance with one or more embodiments. As shown in FIG. 1, a video frame encoding system 100 receives an input 102, as shown at numeral 1. For example, the video frame encoding system 100 receives the input 102 from a user via a computing device or from a memory or storage location. In one or more embodiments, the input 102 includes a video sequence 104. In one or more embodiments, the input 102 can be provided through the use of a graphical user interface (GUI). In one or more embodiments, the input 102 can be uploaded directly or the user can provide a URL to a location storing the input 102.

The video frame encoding system 100 includes an input analyzer 106 that receives the input 102. In some embodiments, the input analyzer 106 is configured to extract video sequence 104 from the input 102, at numeral 2. In one or more embodiments, the input analyzer 106 obtains a set of I-frames and a set of P-frames. I-frames are self-contained, fully formed video frames, such as JPEG or Bitmap image files. P-frames are frames that indicate the pixel-wise differences or changes between a frame and a previous I-frame. For P-frames, darker pixels correspond to a greater difference from the previous I-frame, while lighter pixels correspond to a smaller difference from the previous I-frame. As P-frames store the differences between two I-frames, P-frames do not have to store information for unchanging pixels, which can result in a savings of storage resources.

In some embodiments, the I-frames and P-frames can be extracted directly from the video codec of the video sequence 104, either by the input analyzer 106 or another module or system. In other embodiments, a video frame extraction process can be performed by decoding the video sequence 104 to produce fully-formed video frames (e.g., I-frames) for the entire video sequence 104 or a selected segment of the video sequence 104. Using the fully-formed I-frames, the input analyzer 106, or another module or system, can select one or more I-frames (e.g., at a default or configurable time interval or video frame interval) as anchor frames to be processed through a full foundation visual encoder (e.g., visual encoder 112). The input analyzer 106, or another module or system, can further generate P-frames (e.g., residual video frame representations) of the remaining I-frames of the video sequence (e.g., the video frames excluding the anchor frames). In one or more embodiments, for each I-frame in between the anchor I-frames, its corresponding P-frame is generated based on the pixel-wise difference between the I-frame and the nearest previous anchor I-frame. In FIG. 1, full video frame 108, xₜ, is an I-frame at time t and residual video frame 110, xₜ₊ₖ, is a P-frame at time t+k, which is subsequent to the full video frame 108 in the video sequence 104.

After obtaining the full video frame 108 (e.g., by extracting it from the video sequence 104), the input analyzer 106 sends the full video frame 108 to visual encoder 112, as shown at numeral 3. In one or more embodiments, the visual encoder 112, [symbol] , is the CLIP full foundation model. In other embodiments, the visual encoder 112 can be other full foundation models, including image-text or image-only models. In one or more embodiments, the visual encoder 112 generates first visual features 114, fₜ, or a feature vector representation, of the full video frame 108, at numeral 4. Serially, or in parallel, the input analyzer 106 sends the residual video frame 110 to lightweight visual encoder 116, as shown at numeral 5. In one or more embodiments, the lightweight visual encoder 116 is configured to have a smaller capacity and higher compute efficiency than the full foundation visual encoder 112. In one or more embodiments, the lightweight visual encoder 116, [symbol] , generates residual visual features 118, \tilde{f}ₜ₊ₖ, or a feature vector representation, of the residual video frame 110, at numeral 6.

In one or more embodiments, the residual visual features 118 generated by the lightweight visual encoder 116 are sent to a visual features aggregation module 120, as shown at numeral 7. The first visual features 114 for the full video frame 108 are also sent to the visual features aggregation module 120, as shown at numeral 8. The visual features aggregation module 120 performs an aggregation operation, φ, on the first visual features 114 for the full video frame 108 (e.g., an anchor I-frame) and the residual visual features 118 for the residual video frame 110 (e.g., a P-frame) to generate second visual features 122, fₜ₊ₖ, at numeral 9. Letting fₜ∈ [symbol] ^{d} represent a feature vector computed at timestep t using the full foundation visual encoder 112, where d is the feature dimension, and \tilde{f}ₜ₊ₖ∈ [symbol] ^{d} represent a feature vector computed at timestep t+k using the lightweight visual encoder 116, the aggregation of the feature vectors can be an element-wise summation of the values of the two feature vector representations or a concatenation and projection.

In one or more embodiments, the element-wise summation of the values of the two feature vector representations using an aggregation function:

$$ϕ : {ℝ}^{d} \times {ℝ}^{d} \to {ℝ}^{d}$$

can be expressed as follows:

$${f}_{t + k} = ϕ ( {f}_{t} , {\tilde{f}}_{t + k} ) = ℳ ( {x}_{t} ) ⊕ ℱ ( {x}_{t + k} )$$

where ⊕ denotes the element-wise addition.

In other embodiments, the aggregation operation can be a more complex concatenation followed by a projection layer using a linear transformation. In such embodiments, the first visual features 114 for the full video frame 108 and the residual visual features 118 for the residual video frame 110 are concatenated channel-wise, as follows:

$$c = ( {x}_{t} ‖ {x}_{t + k} ) ∈ {ℝ}^{2 d}$$

and applying a linear transformation. In one or more embodiments, the aggregation function,

$$ϕ : {ℝ}^{2 d} \to {ℝ}^{d}$$

can be expressed as follows:

$$ϕ ( c ) = 𝒜 c + b = 𝒜 ( {x}_{t} ‖ {x}_{t + k} ) + b$$

where [symbol] ∈ [symbol] ^{d×2d} is the weight matrix and b∈ [symbol] ^{d} is the bias vector of the linear transformation.

The process described in numerals 5-9 can be repeated with subsequent full video frames 108 and residual video frames 110. For example, to generate third visual features for a next residual video frame 110, a P-frame at time t+k+1, the residual visual features 118 for the residual video frame 110 for time t+k+1 are sent to the lightweight visual encoder 116. The lightweight visual encoder 116 then generates residual visual features 118 for the residual video frame 110 for time t+k+1, which are then aggregated with the first visual features 114 for the full video frame 108 (e.g., the nearest previous anchor I-frame). The first visual features 114 generated by the full foundation visual encoder 112 for the full video frame 108 are used for aggregation with residual visual features 118 until a second full frame (e.g., a second anchor I-frame) is reached, at which point, the visual features for the second anchor I-frame are then used for aggregation with subsequent residual visual features 118, and so on.

The first visual features 114 generated by the full foundation visual encoder 112 can be sent to a visual features combiner 124, at numeral 10. The second visual features 122 generated by the visual features aggregation module 120 can be sent to the visual features combiner 124, at numeral 11. The visual features combiner 124 can then combine the first visual features 114 and the second visual features 122 to generate the video sequence visual features 126 representing the entire video sequence 104, or a selected segment of the video sequence 104, at numeral 12.

After the video frame encoding system generates the video sequence visual features 126 for the video sequence 104, or a selected segment of the video sequence 104, the video sequence visual features 126 can be sent as an output 130, as shown at numeral 13. In one or more embodiments, after the process described above in numerals 1-12, the output 130 is sent through a communications channel to the user device or computing device that provided the input requesting the encoding of the visual features of the video sequence 104, to another computing device associated with the user or another user, or to another system or application.

In one or more embodiments, the visual features can be stored and/or associated with the video sequence in a media catalog or library. The visual features for the video sequence can be used for searching the media catalog or library based on a query. Additional use cases for the lightweight video encoder can include systems that use visual features from video, such as systems that perform action recognition, activity detection, video captioning, temporal activity localization, video summarization, and video question answering.

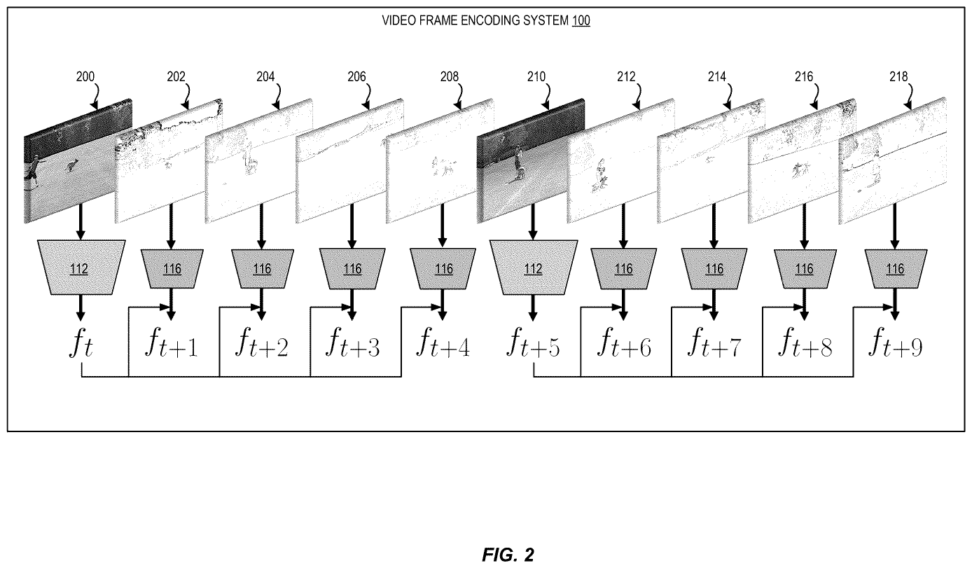

FIG. 2 illustrates exemplary video frames processed through a video frame encoding system in accordance with one or more embodiments. In FIG. 2, video frames 200-218 are processed by the video frame encoding system 100. Video frame 200 and video frame 210 are fully formed video frames (e.g., I-frames) that are passed to visual encoder 112 to generate visual features fₜ and fₜ₊₅, respectively. Residual video frames 202-208 and residual video frames 212-218 are P-frames that represent the pixel-wise differences between a corresponding I-frame and the nearest previous anchor frame. For example, residual video frame 202 is a residual video frame representing the differences between a P-frame at time t+1 and video frame 200 at time t. Similarly, residual video frame 208 is a residual video frame representing the differences between a P-frame at time t+4 and video frame 200 at time t, residual video frame 212 is a residual video frame representing the differences between a P-frame at time t+6 and video frame 210 at time t+5, and so on. To generate the residual visual features for the residual video frames 202-208 and residual video frames 212-218, \tilde{f}ₜ₊₁-\tilde{f}ₜ₊₄ and \tilde{f}ₜ₊₆-\tilde{f}ₜ₊₉, respectively, the corresponding residual video frames are passed to lightweight visual encoder 116. Then, to generate the full visual features for the full video frames being represented by residual video frames 202-208 and residual video frames 212-218, the visual features generated for the nearest previous I-frame (e.g., visual features fₜ and fₜ₊₅) are aggregated with the visual features generated by lightweight visual encoder 116 by a visual features aggregation module (e.g., visual features aggregation module 120 in FIG. 1). For example, visual features \tilde{f}ₜ₊₁ for the second video frame represented by residual video frame 202 are generated by aggregating visual features fₜ with the output from processing residual video frame 202 through the lightweight visual encoder 116. Similarly, visual features fₜ₊₆ for the seventh video frame represented by residual video frame 212 are generated by aggregating visual features fₜ₊₅ with the output from processing residual video frame 212 through the lightweight visual encoder 116 (e.g., visual features \tilde{f}ₜ₊₆). This process can be repeated for each of the remaining residual video frames. The visual features generated (e.g., fₜ₊₁ to fₜ₊₉) can then be passed to a visual features combiner (e.g., visual features combiner 124 in FIG. 1) as the video sequences visual features.

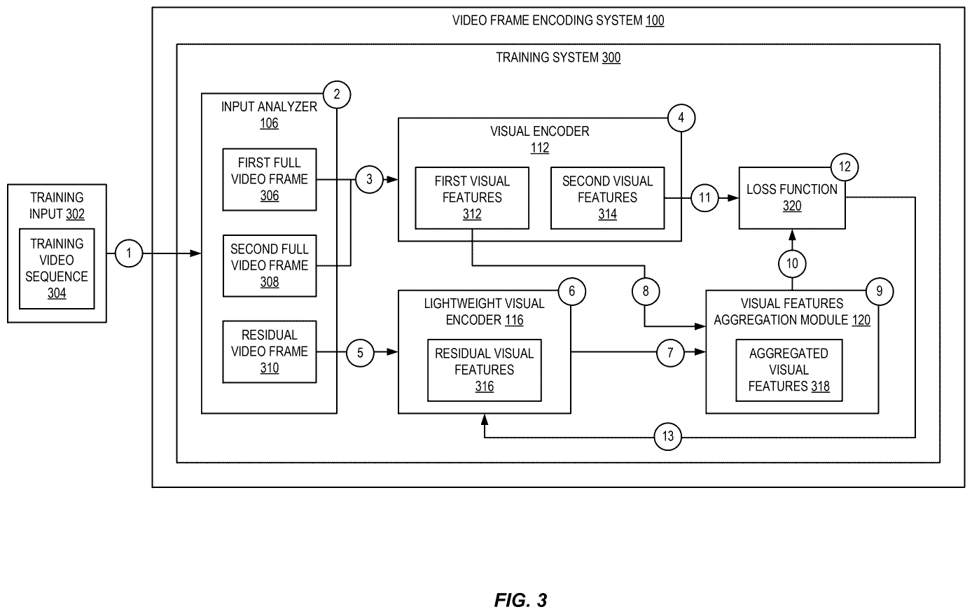

FIG. 3 illustrates a diagram of a process of training a lightweight visual encoder of a video frame encoding system to generate visual features using residual video frames in accordance with one or more embodiments. As illustrated in FIG. 3, a video frame encoding system includes a training system 300. The training system 300 includes a visual encoder 112 and a lightweight visual encoder 116. In one or more embodiments, the training system 300 is configured to train the lightweight visual encoder 116 to capture the visual features of a residual video frame that is sent in place of a fully formed video frame. For example, in FIG. 3, the lightweight visual encoder 116 is trained to obtain the visual features of second full video frame 308 by processing a residual video frame 310 that represents the pixel-wise difference between the second full video frame 308 and a first full video frame 306. In some embodiments, the training system 300 is a part of a video frame encoding system 100. In other embodiments, the training system 300 can be a standalone system, or part of another system, and deployed to the video frame encoding system 100. For example, the training system 300 may be implemented as a separate system implemented on electronic devices separate from the electronic devices implementing video frame encoding system 100. As shown in FIG. 3, the training system 300 receives a training input 302, at numeral 1. For example, the video frame encoding system 100 receives the training input 302 from a user via a computing device or from a memory or storage location. The training input 302 can include a training video sequence 304.

The video frame encoding system 100 includes an input analyzer 106 that receives the input 102. In some embodiments, the input analyzer 106 is configured to extract the training video sequence 304 from the training input 302, at numeral 2. In one or more embodiments, the input analyzer 106 obtains a set of I-frames and a set of P-frames, where I-frames are self-contained, fully formed video frames, such as JPEG or Bitmap image files, and P-frames are frames that indicate the pixel-wise differences or changes between a frame and a previous I-frame.

In some embodiments, the I-frames and P-frames can be extracted directly from the video codec of the training video sequence 304, either by the input analyzer 106 or another module or system. In other embodiments, a video frame extraction process can be performed by decoding the training video sequence 304 to produce fully-formed video frames (e.g., I-frames) for the entire training video sequence 304 or a selected segment of the training video sequence 304. Using the fully-formed I-frames, the input analyzer 106, or another module or system, can select one or more I-frames (e.g., at a default or configurable time interval or video frame interval) as anchor frames to be processed through a full foundation visual encoder (e.g., visual encoder 112). The input analyzer 106, or another module or system, can further generate P-frames (e.g., residual video frame representations) of the remaining I-frames of the video sequence (e.g., the video frames excluding the anchor frames). In one or more embodiments, for each I-frame in between the anchor I-frames, its corresponding P-frame is generated based on the pixel-wise difference between the I-frame and the nearest previous anchor I-frame.

In FIG. 3, the extracted video frames include first full video frame 306 and second full video frame 308, both I-frames, and residual video frame 310, a P-frame representing the pixel-wise differences between the first full video frame 306 and the second full video frame 308.

The input analyzer 106 then sends the first full video frame 306 and the second full video frame 308 to visual encoder 112, as shown at numeral 3. In embodiments, the visual encoder 112 is the Teacher architecture, T. In one or more embodiments, the visual encoder 112 is the CLIP full foundation model. In other embodiments, the visual encoder 112 can be other full foundation models, including image-text or image-only models. In one or more embodiments, the visual encoder 112 generates first visual features 312 and second visual features 314, at numeral 4. The first visual features 312 and the second visual features 314 are feature vector representations of the first full video frame 306 and the second full video frame 308, respectively. Serially, or in parallel, the input analyzer 106 sends the residual video frame 310 to lightweight visual encoder 116, as shown at numeral 5. In one or more embodiments, the lightweight visual encoder 116 generates residual visual features 316, or a feature vector representation, of the residual video frame 310, at numeral 6. In embodiments, the lightweight visual encoder 116 is the Student architecture, S.

In one or more embodiments, the residual visual features 316 generated by the lightweight visual encoder 116 are sent to a visual features aggregation module 120, as shown at numeral 7. The first visual features 312 for the first full video frame 306 are also sent to the visual features aggregation module 120, as shown at numeral 8. The visual features aggregation module 120 performs an aggregation operation on the first visual features 312 for the first full video frame 306 and the residual visual features 316 for the residual video frame 310 to generate aggregated visual features 318, at numeral 9. In one or more embodiments, the aggregation operation can be a simple element-wise summation of the two feature vector representations, or a more complex concatenation followed by a projection using a linear transformation, as described above with respect to FIG. 1.

The aggregated visual features 318,

$${f}_{t + k}^{S} ,$$

are then passed to the loss function 320, as shown at numeral 10. The second visual features 314,

$${f}_{t + k}^{T} ,$$

are also passed to the loss function 320, as shown at numeral 11. The aggregation of the first visual features 312 for the first full video frame 306 and the residual visual features 316 for the residual video frame 310 into the aggregated visual features 318 approximate the visual features of the second full video frame 308 without having to process the second full video frame 308 through the full foundation model (e.g., visual encoder 112).

Using the second visual features 314 and the residual visual features 316, the loss function 320 can calculate a loss, at numeral 12. In one or more embodiments, a distillation loss can be calculated, as follows:

$${Loss}_{distill} = Θ ( {f}_{t + k}^{S} , {f}_{t + k}^{T} )$$

where Θ is a distillation loss. Example distillation losses can include an L2 loss, a smooth L1, etc.

The calculated loss can then be backpropagated to train parameters of the lightweight visual encoder 116, as shown at numeral 13. In embodiments, backpropagating the loss teaches the lightweight visual encoder 116 to produce output features that closely align with the output features of the visual encoder 112.

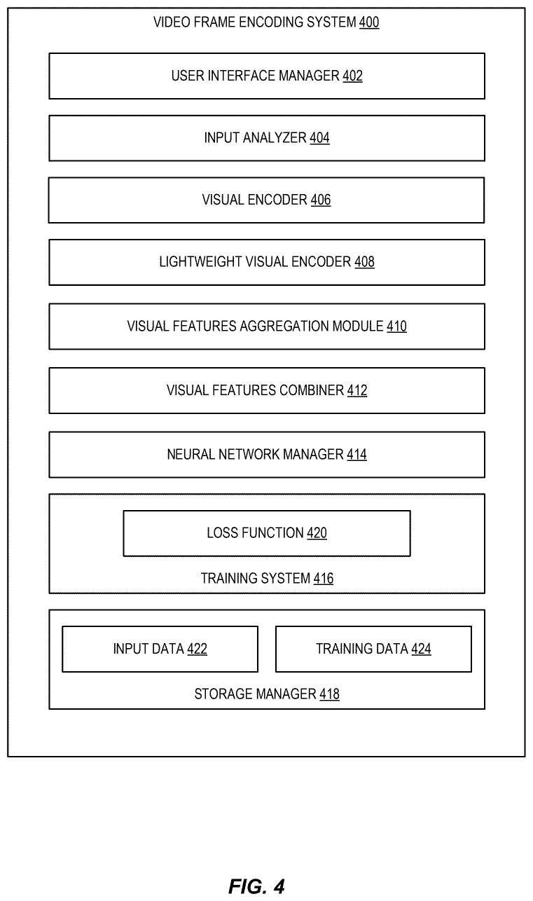

FIG. 4 illustrates a schematic diagram of a video frame encoding system (e.g., “video frame encoding system” described above) in accordance with one or more embodiments. As shown, the video frame encoding system 400 may include, but is not limited to, a user interface manager 402, an input analyzer 404, a visual encoder 406, a lightweight visual encoder 408, a visual features aggregation module 410, a visual features combiner 412, a neural network manager 414, a training system 416, and a storage manager 418. The storage manager 418 includes input data 422 and training data 424.

As illustrated in FIG. 4, the video frame encoding system 400 includes a user interface manager 402. For example, the user interface manager 402 allows users to provide input data to the video frame encoding system 400. In some embodiments, the user interface manager 402 provides a user interface through which the user can upload one or more of video sequences, as discussed above. Alternatively, or additionally, the user interface may enable the user to download one or more of the video sequences from a local or remote storage location (e.g., by providing an address (e.g., a URL or other endpoint) associated with a data source).

As further illustrated in FIG. 4, the video frame encoding system 400 also includes an input analyzer 404. The input analyzer 404 analyzes an input received by the video frame encoding system 400 to identify video sequences and training video sequences. The input analyzer 404 can further extract video frames from input video sequences and training video sequences, including one or more fully-formed video frames (e.g., I-frames) and one or more residual video frames (e.g., P-frames).

As further illustrated in FIG. 4, the video frame encoding system 400 also includes visual encoder 406. In one or more embodiments, the visual encoder 406 generates visual features, or a feature vector representation, of input video frames. In one or more embodiments, the visual features are n-dimensional vectors of numerical features that represent a corresponding video frame. In one or more embodiments, the visual encoder 406 is the CLIP full foundation model that extracts features from fully formed video frames (e.g., JPEG files, Bitmap files, etc.). In other embodiments, the encoder 406 can be other full foundation models, including image-text or image-only models.

As further illustrated in FIG. 4, the video frame encoding system 400 also includes lightweight visual encoder 408. In one or more embodiments, the lightweight visual encoder 408 generates visual features, or a feature vector representation, of input video frames. The lightweight visual encoder 408 is trained to approximate the visual features computed by the visual encoder 406 at a same time step. In one or more embodiments, the visual features are n-dimensional vectors of numerical features that represent a corresponding video frame. In one or more embodiments, the lightweight visual encoder 408 is a high-efficiency, low-capacity encoder that extracts features from residual video frames (e.g., video frames that represent the pixel-wise difference between two fully formed video frames).

As further illustrated in FIG. 4, the video frame encoding system 400 also includes a visual features aggregation module 410. The visual features aggregation module 410 is configured to perform an aggregation operation on the visual features generated by the visual encoder 406 on a first video frames (e.g., a fully-formed video frame, or anchor I-frame) and the residual visual features generated by the lightweight visual encoder 408 for a residual video frame (e.g., a P-frame representing the pixel-wise differences between the first video frame and a second video frame) to generate an approximation of the visual features of the second video frame. In one or more embodiments, the aggregation operation can be a simple element-wise summation of the two feature vector representations or a more complex concatenation followed by a projection using a linear transformation.

As further illustrated in FIG. 4, the video frame encoding system 400 also includes a visual features combiner 412. In one or more embodiments, the visual features combiner 412 is configured to combine the visual features generated for the fully-formed video frames by the visual encoder 406 and the aggregated visual features generated using the output of the lightweight visual encoder 408. The combined visual features can then be provided as an output for the input video sequence or a selected segment of the input video sequence.

As illustrated in FIG. 4, the video frame encoding system 400 also includes a neural network manager 414. Neural network manager 414 may host a plurality of neural networks or other machine learning models, such as visual encoder 406 and lightweight visual encoder 408. The neural network manager 414 may include an execution environment, libraries, and/or any other data needed to execute the machine learning models. In some embodiments, the neural network manager 414 may be associated with dedicated software and/or hardware resources to execute the machine learning models. Although depicted in FIG. 4 as being hosted by a single neural network manager 414, in various embodiments the neural networks may be hosted in multiple neural network managers and/or as part of different components.

As illustrated in FIG. 4 the video frame encoding system 400 also includes training system 416. The training system 416 can teach, guide, tune, and/or train one or more neural networks. In particular, the training system 416 can train a neural network based on a plurality of training data. More specifically, the training system 416 can access, identify, generate, create, and/or determine training input and utilize the training input to train and fine-tune a neural network. In particular, the training system 416 can train, at least, the lightweight visual encoder 408, based on training data, and using loss function 420.

As illustrated in FIG. 4, the video frame encoding system 400 also includes the storage manager 418. The storage manager 418 maintains data for the video frame encoding system 400. The storage manager 418 can maintain data of any type, size, or kind as necessary to perform the functions of the video frame encoding system 400. The storage manager 418, as shown in FIG. 4, includes input data 422 and training data 424. In particular, the input data 422 may include video sequences received by the video frame encoding system 400. In one or more embodiments, the input data 422 can include video frames extracted from video sequences, including fully-formed video frames (e.g., I-frames) and residual video frames (e.g., P-frames). The training data 424 can include one or more video sequences, as discussed in additional detail above. In particular, in one or more embodiments, the training data 424 includes training video sequences utilized by the training system 416 to train one or more neural networks, including the lightweight visual encoder 408.

Each of the components 402-418 of the video frame encoding system 400 and their corresponding elements (as shown in FIG. 4) may be in communication with one another using any suitable communication technologies. It will be recognized that although components 402-418 and their corresponding elements are shown to be separate in FIG. 4, any of components 402-418 and their corresponding elements may be combined into fewer components, such as into a single facility or module, divided into more components, or configured into different components as may serve a particular embodiment.

The components 402-418 and their corresponding elements can comprise software, hardware, or both. For example, the components 402-418 and their corresponding elements can comprise one or more instructions stored on a computer-readable storage medium and executable by processors of one or more computing devices. When executed by the one or more processors, the computer-executable instructions of the video frame encoding system 400 can cause a client device and/or a server device to perform the methods described herein. Alternatively, the components 402-418 and their corresponding elements can comprise hardware, such as a special purpose processing device to perform a certain function or group of functions. Additionally, the components 402-418 and their corresponding elements can comprise a combination of computer-executable instructions and hardware.

Furthermore, the components 402-418 of the video frame encoding system 400 may, for example, be implemented as one or more stand-alone applications, as one or more modules of an application, as one or more plug-ins, as one or more library functions or functions that may be called by other applications, and/or as a cloud-computing model. Thus, the components 402-418 of the video frame encoding system 400 may be implemented as a stand-alone application, such as a desktop or mobile application. Furthermore, the components 402-418 of the video frame encoding system 400 may be implemented as one or more web-based applications hosted on a remote server. Alternatively, or additionally, the components of the video frame encoding system 400 may be implemented in a suite of mobile device applications or “apps.”

As shown, the video frame encoding system 400 can be implemented as a single system. In other embodiments, the video frame encoding system 400 can be implemented in whole, or in part, across multiple systems. For example, one or more functions of the video frame encoding system 400 can be performed by one or more servers, and one or more functions of the video frame encoding system 400 can be performed by one or more client devices. The one or more servers and/or one or more client devices may generate, store, receive, and transmit any type of data used by the video frame encoding system 400, as described herein.

In one implementation, the one or more client devices can include or implement at least a portion of the video frame encoding system 400. In other implementations, the one or more servers can include or implement at least a portion of the video frame encoding system 400. For instance, the video frame encoding system 400 can include an application running on the one or more servers or a portion of the video frame encoding system 400 can be downloaded from the one or more servers. Additionally or alternatively, the video frame encoding system 400 can include a web hosting application that allows the client device(s) to interact with content hosted at the one or more server(s).

For example, upon a client device accessing a webpage or other web application hosted at the one or more servers, in one or more embodiments, the one or more servers can provide access to one or more files including a video sequences and/or training video sequences stored at the one or more servers. Moreover, the client device can receive a request (i.e., via user input) to generate visual features for frames of the video sequences and/or training video sequences. Upon receiving the request, the one or more servers can automatically perform the methods and processes described above.

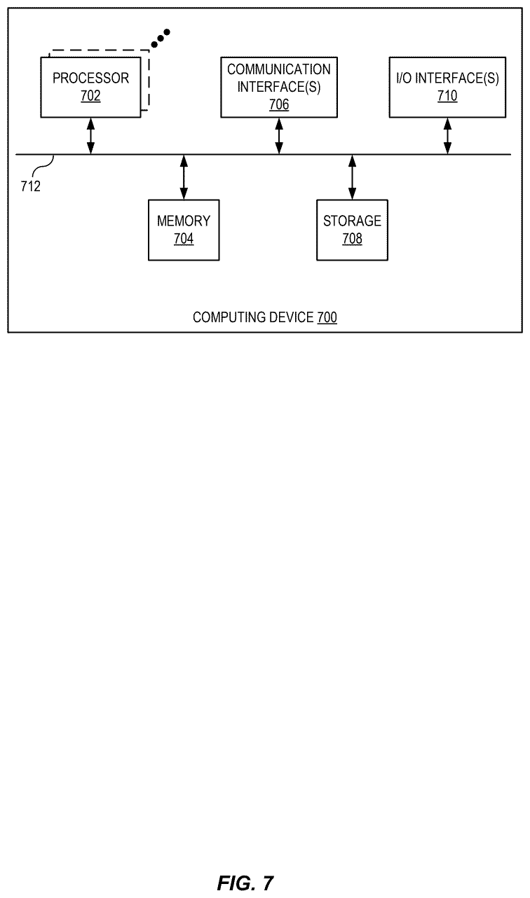

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 7. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 7.

The server(s) may include one or more hardware servers (e.g., hosts), each with its own computing resources (e.g., processors, memory, disk space, networking bandwidth, etc.) which may be securely divided between multiple customers (e.g., client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 7.

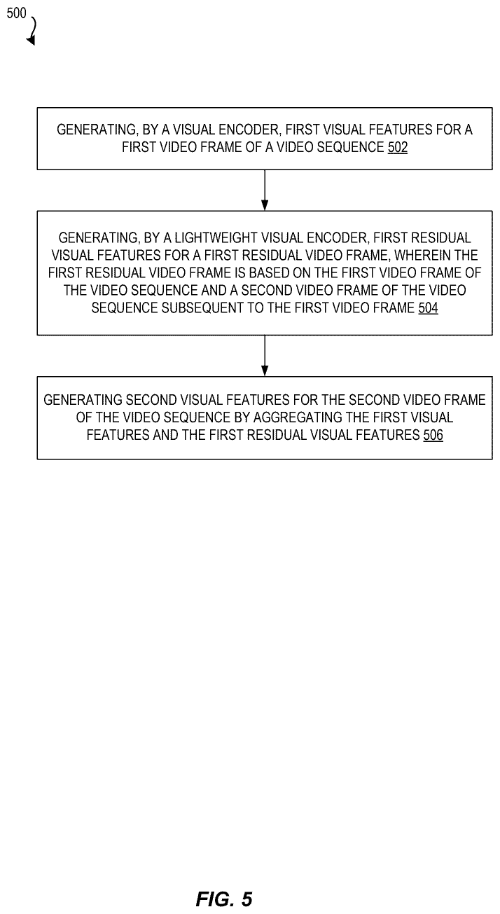

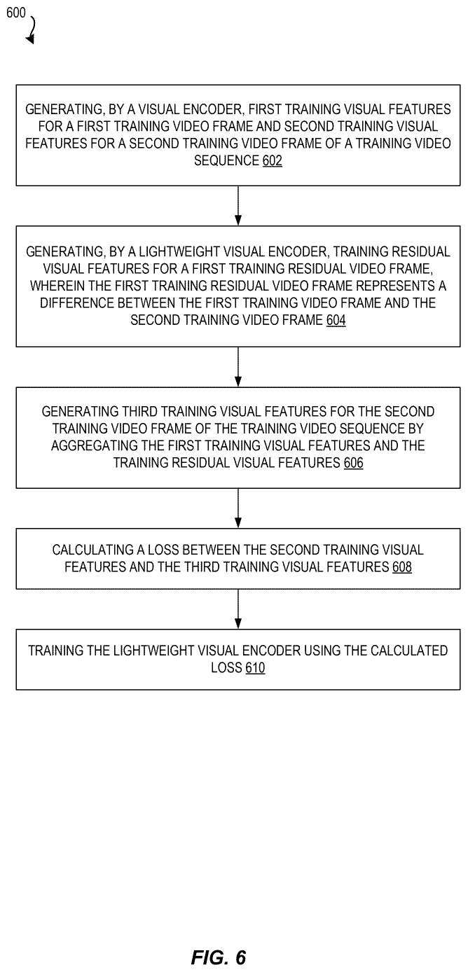

FIGS. 1-4, the corresponding text, and the examples, provide a number of different systems and devices that efficiently generate visual features from video frames of a video sequence using a trained lightweight visual encoder. In addition to the foregoing, embodiments can also be described in terms of flowcharts comprising acts and steps in a method for accomplishing a particular result. For example, FIGS. 5 and 6 illustrate flowcharts of exemplary methods in accordance with one or more embodiments. The method described in relation to FIGS. 5 and 6 may be performed with fewer or more steps/acts or the steps/acts may be performed in differing orders. Additionally, the steps/acts described herein may be repeated or performed in parallel with one another or in parallel with different instances of the same or similar steps/acts.

FIG. 5 illustrates a flowchart of a series of acts in a method of generating visual features for frames of a video sequence using a lightweight visual encoder in accordance with one or more embodiments. In one or more embodiments, the method 500 is performed in a digital medium environment that includes the video frame encoding system 400. The method 500 is intended to be illustrative of one or more methods in accordance with the present disclosure and is not intended to limit potential embodiments. Alternative embodiments can include additional, fewer, or different steps than those articulated in FIG. 5.

As illustrated in FIG. 5, the method 500 includes an act 502 of generating, by a visual encoder, first visual features for a first video frame of a video sequence. In one or more embodiments, a video frame encoding system receives a video sequence as an input. In one or more embodiments, the video frame encoding system receives the input from a user (e.g., via a computing device). In one or more embodiments, the user may select or provide the input in an application, or the user may submit the input to a web service or an application configured to receive inputs.

In one or more embodiments, the video frame encoding system extracts a set of I-frames and a set of P-frames from the video sequence (e.g., from the video codec). I-frames are self-contained, fully formed video frames, such as JPEG or Bitmap image files. P-frames are frames that indicate the pixelwise differences or changes between a frame and a previous I-frame. For P-frames, darker pixels correspond to a greater difference from the previous I-frame, while lighter pixels correspond to a smaller difference from the previous I-frame. As P-frames store the differences between two I-frames, P-frames do not have to store information for unchanging pixels, which can result in a savings of storage resources. In other embodiments, the video frame encoding system generates the first residual video frame based on determining the pixelwise differences between the first video frame of the video sequence and the second video frame of the video sequence.

In one or more embodiments, the first video frame is an I-frame that is then sent to a visual encoder. In some embodiments, the visual encoder is the CLIP full foundation model, or another full foundation model, including image-text or image-only models. In one or more embodiments, the visual encoder generates first visual features, or a feature vector representation, of the first video frame.

As illustrated in FIG. 5, the method 500 includes an act 504 of generating, by a lightweight visual encoder, first residual visual features for a first residual video frame. In one or more embodiments, the first residual video frame is based on the first video frame of the video sequence and a second video frame of the video sequence subsequent to the first video frame. For example, the first residual video frame is based on pixelwise differences between the first video frame of the video sequence and the second video frame of the video sequence. In one or more embodiments, the lightweight visual encoder generates residual visual features, or a feature vector representation, of the residual video frame.

As illustrated in FIG. 5, the method 500 includes an act 506 of generating second visual features for the second video frame of the video sequence by aggregating the first visual features and the first residual visual features. The video frame encoding system then can aggregate the first visual features generated by the visual encoder for the first video frame and the residual visual features generated by the lightweight visual encoder for the residual video frame (e.g., representing the changes from the first video frame to a second video frame subsequent to the first video frame) to generate an estimate of the second visual features for the second video frame.

In one or more embodiments, the process can be repeated for each subsequent residual video frame of the video sequence. For example, for a third video frame of the video sequence, a second residual video frame can be obtained or generated. The second residual video frame is based on pixelwise differences between the third video frame of the video sequence and the first video frame of the video sequence (e.g., the closest previous I-frame to the third video frame). Second residual visual features are generated for the second residual video frame, and the second residual visual features are then aggregated with the first visual features for the first video frame to generate the third visual features for the third video frame.

Once the visual features are generated for the video sequence, or segment of the video sequence, the visual features can be stored and/or associated with the video sequence in a media catalog or library. The visual features for the video sequence can be used for searching the media catalog or library based on a query.

FIG. 6 illustrates a flowchart of a series of acts in a method of training a lightweight visual encoder to generate visual features for frames of video sequences in accordance with one or more embodiments. In one or more embodiments, the method 600 is performed in a digital medium environment that includes the video frame encoding system 400. The method 600 is intended to be illustrative of one or more methods in accordance with the present disclosure and is not intended to limit potential embodiments. Alternative embodiments can include additional, fewer, or different steps than those articulated in FIG. 6.

As illustrated in FIG. 6, the method 600 includes an act 602 of generating, by a visual encoder, first training visual features for a first training video frame and second training visual features for a second training video frame of a training video sequence. In one or more embodiments, a video frame encoding system (e.g., video frame encoding system 400) receives the training input that includes a training video sequence. The training input can be part of a batch that includes multiple training video sequences. In one or more embodiments, the video frame encoding system extracts full video frames (e.g., I-frames) from the training video sequence. In one or more embodiments, the video frame encoding system further extracts residual video frames from the video sequence (e.g., the video codec). In other embodiments, the video frame encoding system can generate residual video frames by determining the pixelwise differences between I-frames.

In embodiments, the visual encoder is the Teacher architecture, T. In one or more embodiments, the visual encoder is the CLIP full foundation model. In other embodiments, the visual encoder can be other full foundation models, including image-text or image-only models. In one or more embodiments, the visual encoder generates first visual features for the first full video frame and second visual features for the second full video frame, respectively. The first visual features and the second visual features are feature vector representations of corresponding full video frames.

As illustrated in FIG. 6, the method 600 includes an act 604 of generating, by a lightweight visual encoder, training residual visual features for a first training residual video frame, wherein the first training residual video frame represents a difference between the first training video frame and the second training video frame. Serially, or in parallel, the residual video frame are sent to a lightweight visual encoder. In one or more embodiments, the lightweight visual encoder generates residual visual features, or a feature vector representation, of the residual video frame. In embodiments, the lightweight visual encoder is the Student architecture, S.

As illustrated in FIG. 6, the method 600 includes an act 606 of generating third training visual features for the second training video frame of the training video sequence by aggregating the first training visual features and the training residual visual features. In one or more embodiments, the aggregation operation used to generate the third training visual features can be a simple element-wise summation of the two feature vector representations or a more complex concatenation followed by a projection using a linear transformation. The third training visual features approximate the visual features of the second full video frame without having to process the second full video frame through the full foundation model (e.g., the visual encoder).

As illustrated in FIG. 6, the method 600 includes an act 608 of calculating a loss between the second training visual features and the third training visual features. The third training visual features generated by the lightweight visual encoder are then passed to a loss function. The second visual features generated by the visual encoder are also passed to the loss function. Using the second visual features and the third training visual features, the loss function can calculate a loss. In one or more embodiments, a distillation loss can be calculated between the second visual features and the third visual features. Example distillation losses can include an L2 loss, a smooth L1, etc.

As illustrated in FIG. 6, the method 600 includes an act 610 of training the lightweight visual encoder using the calculated loss. In one or more embodiments, the calculated loss is backpropagated to the lightweight visual encoder to train parameters of the lightweight visual encoder. In one or more embodiments, backpropagating the loss teaches the lightweight visual encoder to produce output features that closely align with the output features of the visual encoder.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 that may be configured to perform one or more of the processes described above. One will appreciate that one or more computing devices such as the computing device 700 may implement the video frame encoding system. As shown by FIG. 7, the computing device can comprise a processor 702, memory 704, one or more communication interfaces 706, a storage device 708, and one or more I/O devices/interfaces 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 708 and decode and execute them. In various embodiments, the processor(s) 702 may include one or more central processing units (CPUs), graphics processing units (GPUs), field programmable gate arrays (FPGAs), systems on chip (SoC), or other processor(s) or combinations of processors.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The computing device 700 can further include one or more communication interfaces 706. A communication interface 706 can include hardware, software, or both. The communication interface 706 can provide one or more interfaces for communication (such as, for example, packet-based communication) between the computing device and one or more other computing devices 700 or one or more networks. As an example and not by way of limitation, communication interface 706 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can comprise hardware, software, or both that couples components of computing device 700 to each other.

The computing device 700 includes a storage device 708 includes storage for storing data or instructions. As an example, and not by way of limitation, storage device 708 can comprise a non-transitory storage medium described above. The storage device 708 may include a hard disk drive (HDD), flash memory, a Universal Serial Bus (USB) drive or a combination these or other storage devices. The computing device 700 also includes one or more input or output (“I/O”) devices/interfaces 710, which are provided to allow a user to provide input to (such as user strokes), receive output from, and otherwise transfer data to and from the computing device 700. These I/O devices/interfaces 710 may include a mouse, keypad or a keyboard, a touch screen, camera, optical scanner, network interface, modem, other known I/O devices or a combination of such I/O devices/interfaces 710. The touch screen may be activated with a stylus or a finger.

The I/O devices/interfaces 710 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 710 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
generating, by a visual encoder, first visual features for a first video frame of a video sequence;
generating, by a lightweight visual encoder, first residual visual features for a first residual video frame, wherein the first residual video frame is based on the first video frame of the video sequence and a second video frame of the video sequence subsequent to the first video frame; and
generating second visual features for the second video frame of the video sequence by aggregating the first visual features and the first residual visual features.

2. The method of claim 1, further comprising:
generating the first residual video frame based on pixelwise differences between the first video frame of the video sequence and the second video frame of the video sequence.

3. The method of claim 1, further comprising:
extracting the first video frame of the video sequence and one or more residual video frames, including the first residual video frame representing the second video frame of the video sequence, from a video sequence file.

4. The method of claim 2, further comprising:
generating, by the lightweight visual encoder, second residual visual features for a second residual video frame, wherein the second residual video frame is based on the first video frame of the video sequence and a third video frame of the video sequence subsequent to the first video frame; and
generating third visual features for the third video frame of the video sequence by aggregating the first visual features and the second residual visual features.

5. The method of claim 1, wherein the lightweight visual encoder is trained by:
aggregating first training visual features generated by the visual encoder for a first training video frame and training residual features generated by the lightweight visual encoder from a training residual video frame into approximated visual features for a second training 506 video frame, wherein the training residual video frame represents a pixelwise difference between the first training video frame and the second training video frame;
calculating a loss based on the approximated visual features for the second training video frame and second training visual features generated by the visual encoder using the second training video frame; and
training the lightweight visual encoder using the calculated loss.

6. The method of claim 1, wherein generating the second visual features for the second video frame of the video sequence by aggregating the first visual features and the first residual visual features further comprises:
performing an element-wise summation of first values from the first visual features and second values of the first residual visual features.

7. The method of claim 1, wherein generating the second visual features for the second video frame of the video sequence by aggregating the first visual features and the first residual visual features further comprises:
concatenating the first visual features for the first video frame and the first residual visual features for the first residual video frame to generate concatenated features; and
applying a linear transformation to the concatenated features to generate the second visual features for the second video frame of the video sequence.

8. The method of claim 1, further comprising:
selecting a set of anchor video frames from a plurality of video frames of the video sequence at a selected interval, wherein the first video frame is an anchor video frame; and
generating residual video frame representations of video frames of the plurality of video frames excluding the set of anchor video frames.

9. A non-transitory computer-readable medium storing executable instructions, which when executed by a processing device, cause the processing device to perform operations comprising:
generating, by a visual encoder, first visual features for a first video frame of a video sequence;
generating, by a lightweight visual encoder, first residual visual features for a first residual video frame, wherein the first residual video frame is based on the first video frame of the video sequence and a second video frame of the video sequence subsequent to the first video frame; and
generating second visual features for the second video frame of the video sequence by aggregating the first visual features and the first residual visual features.

10. The non-transitory computer-readable medium of claim 9, wherein the instructions further comprise:
generating the first residual video frame based on pixelwise differences between the first video frame of the video sequence and the second video frame of the video sequence.

11. The non-transitory computer-readable medium of claim 9, wherein the instructions further comprise:
extracting the first video frame of the video sequence and one or more residual video frames, including the first residual video frame representing the second video frame of the video sequence, from a video sequence file.

12. The non-transitory computer-readable medium of claim 10, wherein the instructions further comprise:
generating, by the lightweight visual encoder, second residual visual features for a second residual video frame, wherein the second residual video frame is based on the first video frame of the video sequence and a third video frame of the video sequence subsequent to the first video frame; and
generating third visual features for the third video frame of the video sequence by aggregating the first visual features and the second residual visual features.

13. The non-transitory computer-readable medium of claim 9, wherein the lightweight visual encoder is trained by:
aggregating first training visual features generated by the visual encoder for a first training video frame and training residual features generated by the lightweight visual encoder from a training residual video frame into approximated visual features for a second training video frame, wherein the training residual video frame represents a pixelwise difference between the first training video frame and the second training video frame;
calculating a loss based on the approximated visual features for the second training video frame and second training visual features generated by the visual encoder using the second training video frame; and
training the lightweight visual encoder using the calculated loss.

14. The non-transitory computer-readable medium of claim 9, wherein the instructions to generate the second visual features for the second video frame of the video sequence by aggregating the first visual features and the first residual visual features further comprise:
performing an element-wise summation of first values from the first visual features and second values of the first residual visual features.

15. The non-transitory computer-readable medium of claim 9, wherein the instructions to generate the second visual features for the second video frame of the video sequence by aggregating the first visual features and the first residual visual features further comprise:
concatenating the first visual features for the first video frame and the first residual visual features for the first residual video frame to generate concatenated features; and
applying a linear transformation to the concatenated features to generate the second visual features for the second video frame of the video sequence.

16. The non-transitory computer-readable medium of claim 9, wherein the instructions further comprise:
selecting a set of anchor video frames from a plurality of video frames of the video sequence at a selected interval, wherein the first video frame is an anchor video frame; and
generating residual video frame representations of video frames of the plurality of video frames excluding the set of anchor video frames.

17. A system comprising:
a memory component; and
a processing device coupled to the memory component, the processing device to perform operations comprising:
generating, by a visual encoder, first training visual features for a first training video frame and second training visual features for a second training video frame of a training video sequence;
generating, by a lightweight visual encoder, training residual visual features for a first training residual video frame, wherein the first training residual video frame is based on the first training video frame and the second training video frame subsequent to the first training video frame;
generating third training visual features for the second training video frame of the training video sequence by aggregating the first training visual features and the training residual visual features;
calculating a loss between the second training visual features and the third training visual features; and
training the visual encoder using the calculated loss.

18. The system of claim 17, wherein the operations further comprise:
generating the first training residual video frame based on pixelwise differences between the first training video frame of the training video sequence and the second training video frame of the training video sequence.

19. The system of claim 17, wherein the calculated loss is a distillation loss.

20. The system of claim 17, wherein the operations of generating the third training visual features for the second training video frame of the training video sequence by aggregating the first training visual features and the training residual visual features further comprise:
performing an element-wise summation of first values from the first training visual features and second values of the training residual visual features.
